(19) United States
(12) Patent Application Publication
(10) Pub. No.: US 2010/0130045 A1
(43) Pub. Date: May 27, 2010

(54) Connector for Flexible Circuit

(76) Inventor: Kunihiro Higuchi, Osaka (JP)

Correspondence Address: Harrington & Smith, 4 Research Drive, Suite 202, Shelton, CT, 06484, US

(21) Appl. No.: 12/451,260

(22) PCT Filed: May 3, 2007
(86) PCT No.: PCT/IB2007/052709

§ 371 Date: Jan. 19, 2010

(51) Int. Cl. H01R 13/62

(52) U.S. Cl. 439/260

(57) ABSTRACT

A connector to be attached to an end portion of a planar flexible circuit board includes a main body having a support surface on which is placed a portion of the flexible circuit board of a predetermined length from a distal end thereof, the support surface provided with an electrode which contacts a conductor on one surface of the flexible circuit board; and an actuator which holds the flexible circuit board between the actuator and the support surface of the main body. The actuator is pivotably joined to the main body at a base end portion of the actuator, and engages with the main body at a distal end portion of the actuator.

The present invention relates to a connector which makes an electrical connection, in particular, a connector which makes an electrical connection with a flexible circuit board and the like.

There is a need to decrease the size of connectors which make electrical connections and increase the density of terminals in the connectors. In particular, there is a strong need due to the decrease in size and increase in density of modern electronic devices. Moreover, there is a need to facilitate connector mating for the purpose of simplifying the assembly steps.

Connectors such as those disclosed in Unexamined Patent Application, First Publication No. 2005-294054 are known as conventional connectors used for electrical connections of flexible circuit boards and the like. FIG. 9 is a diagram showing such a constitution.

The connector is constituted by a first connector part 81 attached to an end portion of a flexible circuit board or the like, and a second connector part 82 which is the counterpart of the first connector part and which is attached to a substrate or the like.

When the first connector part 81 is attached to the second connector part 82, a first front projection 85 of the first connector part 81 is inserted into a first front receiving portion 87 of the second connector part 82. At this time, a second front projection 95 of the first connector part 81 is also inserted into a second front receiving portion 96 of the second connector part 82.

After the first and second front projections 85, 95 are inserted into their corresponding portions, the first connector part 81 is pushed downward roughly perpendicular with respect to the substrate (not shown). In other words, since the second connector part 82 in FIG. 9 is provided on the substrate, the first connector part 81 is pushed downward roughly perpendicular with respect to the second connector part 82. At this time, there is a latch mechanism which maintains the mating of the first and second connector parts 81, 82, and hook portions 91, 93 respectively make contact with a shoulder portion 92 and an engaging portion (not shown). Accordingly, if further pressed, these hook portions 91, 93 respectively engage with the shoulder portion 92 and the engaging portion, and the first connector part 81 and the second connector part 82 mate. Due to this action, simplification of the mating of the connector parts is realized.

An aim of the invention is to provide for a different solution than the prior art one.

According to the present invention, it is provided a connector according to claim 1.

Other advantageous features of the invention correspond to the dependant claims considered either separately or in combination.

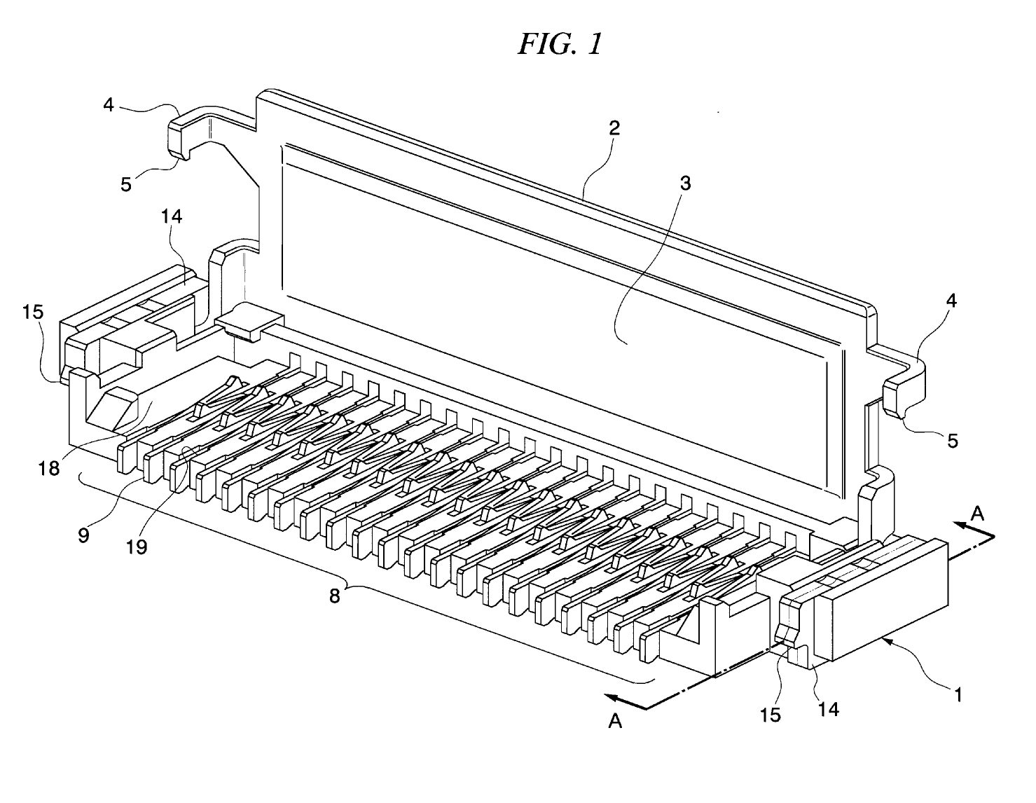

FIG. 1 This is a diagram showing a first embodiment of the present invention.

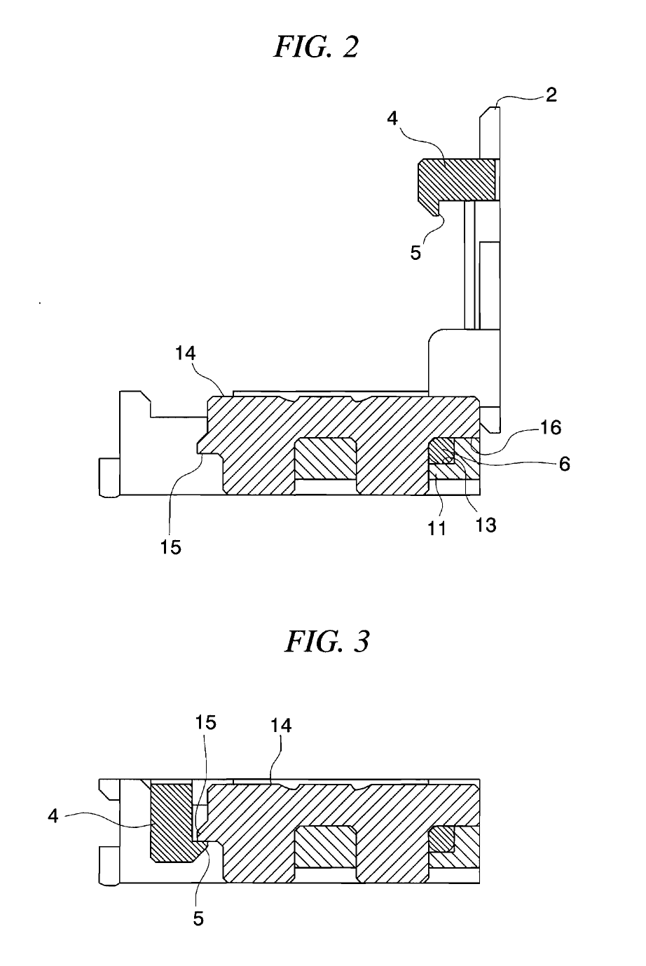

FIG. 2 This is a diagram showing a cross section along direction A-A of FIG. 1 when the actuator is open.

FIG. 3 This is a diagram showing a cross section along direction A-A of FIG. 1 when the actuator is closed.

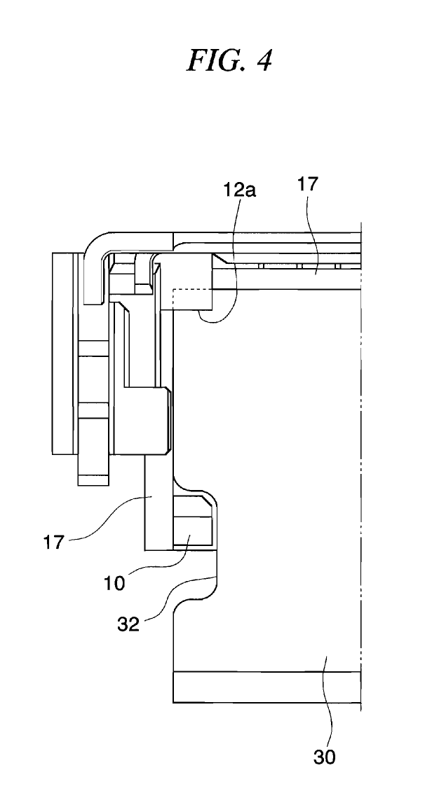

FIG. 4 This is a diagram showing the state in which the flexible circuit board is partially pushed in.

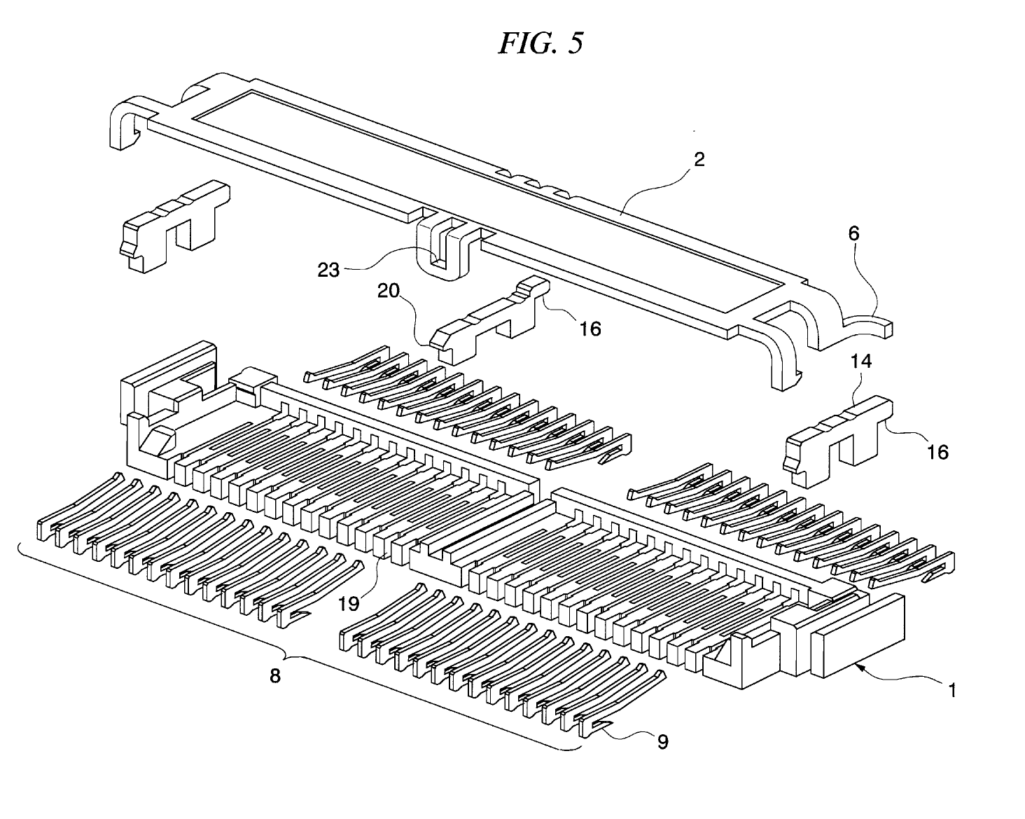

FIG. 5 This is a diagram showing a second embodiment of the present invention.

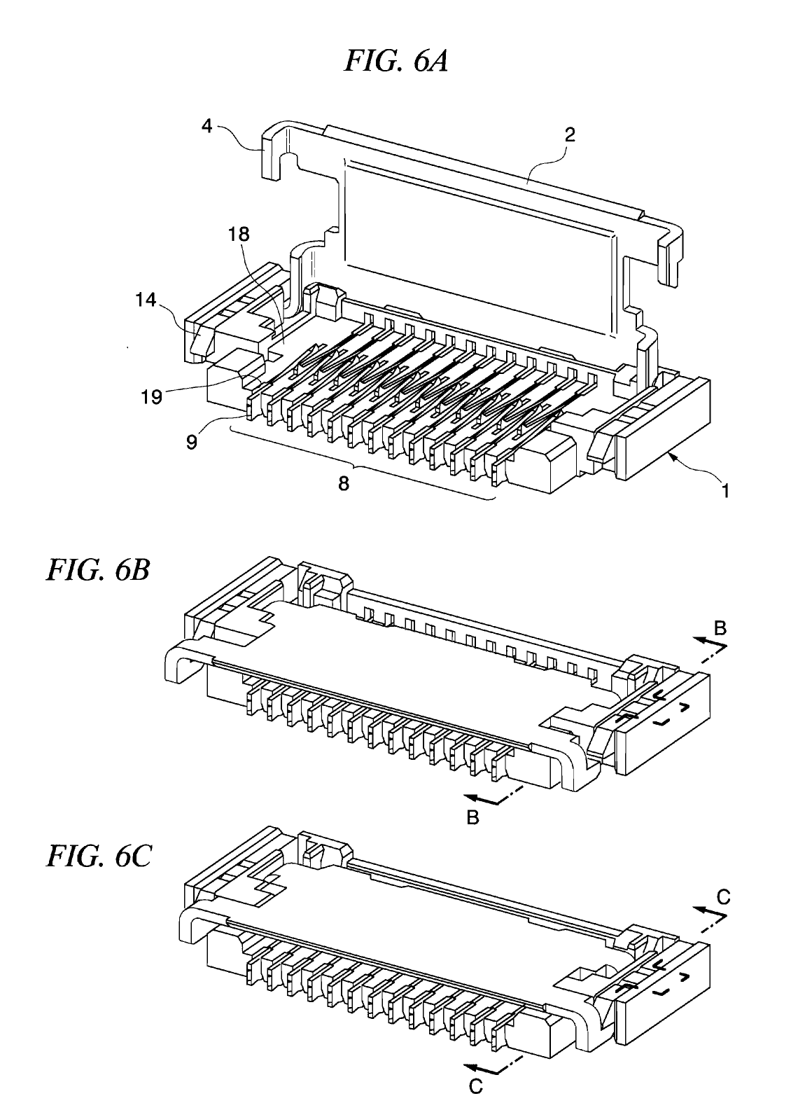

FIG. 6 FIG. 6a is a diagram showing the state in which the actuator of a third embodiment of the present invention is open. FIG. 6b is a diagram showing the state in which the actuator of the third embodiment of the present invention is partially stopped. FIG. 6c is a diagram showing the state in which the actuator of the third embodiment of the present invention is locked.

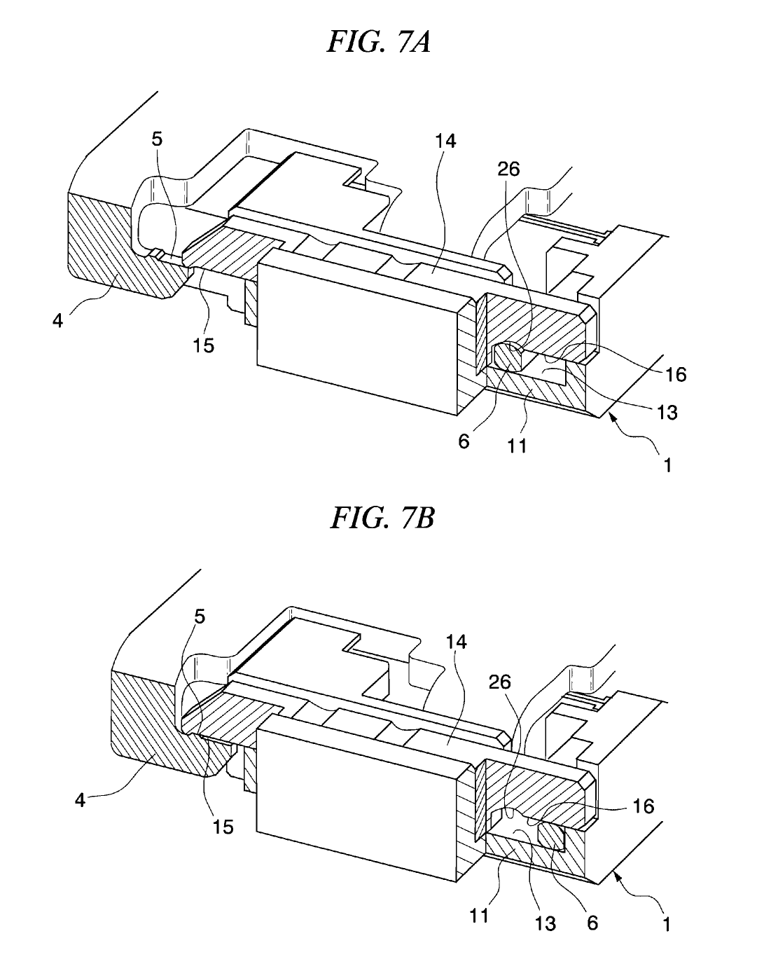

FIG. 7 FIG. 7a is a diagram showing a cross section along direction B-B of FIG. 6b. FIG. 7b is a diagram showing a cross section along direction C-C of FIG. 6c.

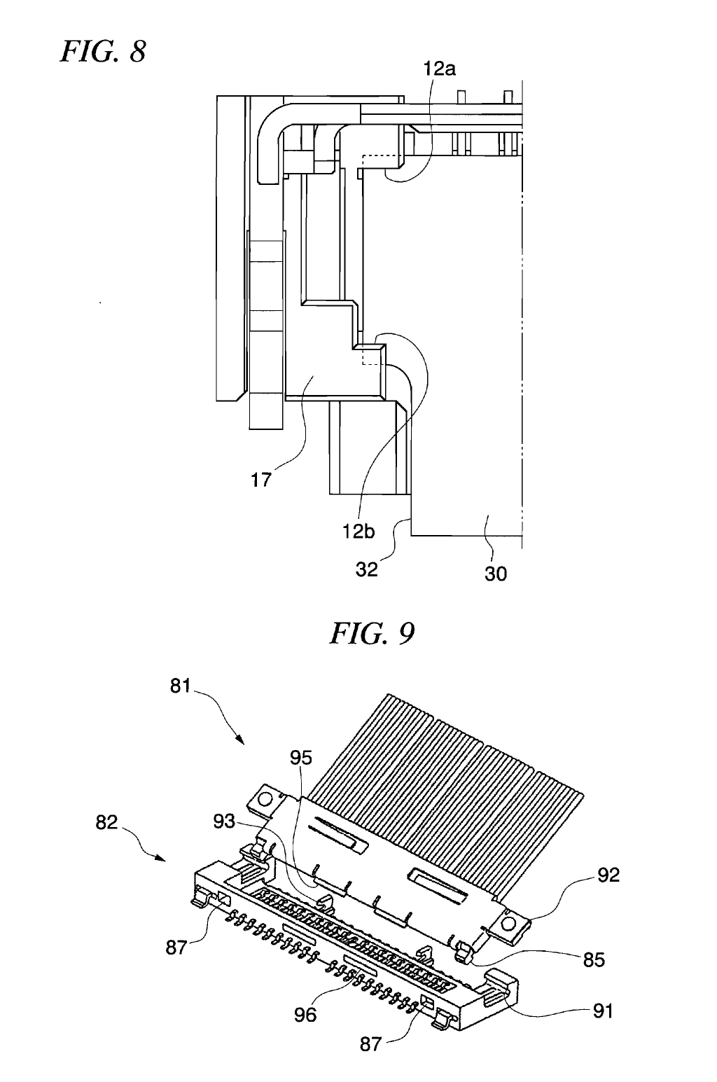

FIG. 8 This is a diagram showing the state in which the flexible circuit board of the third embodiment of the present invention is partially pushed in.

FIG. 9 This is a diagram showing an embodiment of the prior art.

A first embodiment of the present invention will be explained using the drawings. As shown in FIG. 1, a connector attached to an end portion of a planar flexible circuit board 30 (not shown on FIG. 1) is constituted by a main body 1 made of a formed resin, a metal actuator 2 which can be attached to and removed from the main body 1, and lock pieces 14 which are mounted at both sides of the main body 1 and which lock the actuator 2 on the main body 1.

The main body 1 is provided with a support surface 18 on which is placed a portion of the flexible circuit board 30 of a predetermined length from the distal end thereof. On the support surface 18, terminal grooves 19 are formed into which a plurality 8 of terminals 9 will be inserted. The terminals 9 protrude from the terminal grooves 19 so as to contact a conductor on one surface of the flexible circuit board 30.

As shown on FIG. 4, the main body 1 is provided with side walls 17 which surround the support surface 18. At the corner portions of the side walls 17, a slit 12a, into which the corner portions of the distal end of the flexible circuit board 30 are to be inserted, is formed parallel to the support surface 18. A hook 10 which projects upward is provided on the support surface 18 and positions the flexible circuit board 30 on the main body by being inserted into a notch 32 provided on the flexible circuit board 30.

The lock pieces 14 are mounted at both sides of the main body 1 (see FIGS. 1 and 2). Each lock piece 14 is provided with a projection 15 which projects along the insertion direction of the flexible circuit board 30. A notch 16 is also formed on the lock piece 14. The notch 16 and a notch 11, which is formed on the main body 1, together form an opening 13.

The actuator 2 forms a plate shape which has a surface shape that overlaps with the portion of the flexible circuit board 30 of a predetermined length. The portion which overlaps with the flexible circuit board 30 is provided with a protrusion 3 which projects in the thickness direction of the actuator 2. A coating layer made of an insulating resin is provided on the surface of the actuator 2 that includes the protrusion 3 and that touches the flexible circuit board 30.

Furthermore, both sides of the actuator 2 are provided with a lock arm 4 which extends in the thickness direction of the actuator 2. At the distal end portion of the lock arm 4, a projection 5, which engages with the projection 15, projects orthogonally, when the actuator is locked on the main body in a direction parallel to the insertion direction of the flexible circuit board 30.

Moreover, the base end portion of the actuator 2 is provided with a pivot 6 which is orthogonal to the longitudinal direction of the flexible circuit board 30 and parallel to the surface of the flexible circuit board. The actuator 2 is joined to the main body 1 so as to be pivotable about the pivot 6 by insertion of the pivot 6 into the opening 13. Furthermore, the pivot 6 is formed into a polygonal lateral cross-sectional shape with the entirety being chamfered.

Next, the operation of the connector of the present invention as constituted above as well as the effects thereof will be explained. Since the pivot 6 which joins the main body 1 and the actuator 2 is provided with a chamfered polygonal cross-sectional shape, as shown in FIG. 2, the actuator 2 is held in an open state. While the actuator 2 is in an open state, the end of the flexible circuit board 30 is set in the connector from roughly perpendicularly above the connector.

Next, the distal end of the flexible circuit board 30 is inserted into the slit 12a which is formed in the side wall 17 of the connector as shown in FIG. 4. As a result, the flexible circuit board 30 is partially pushed in until the actuator 2 closes so that the flexible circuit board 30 cannot be removed upwards.

The hook 10 provided on the support surface 18 is inserted into the notch 32 formed in the flexible circuit board 30. As a result, the flexible circuit board 30 is positioned with respect to the support surface 18 and prevented from being pulled out in the longitudinal direction.

Thereafter, the actuator 2 is closed by pivoting about the pivot 6. As a result, an electrical connection is completed by holding the flexible circuit board 30 between the actuator 2 and the support surface 18. At the same time, as shown in FIG. 3, the projection 5 provided on the lock arm 4 of the actuator 2 is stopped by the projection 15 provided on the lock piece 14 which is mounted on the main body 1.

Moreover, the hook 10 has a function of detecting a poor insertion state of the flexible circuit board 30. If the flexible circuit board 30 is not properly inserted into the connector, the notch 32 cannot be positioned with the hook 10, the flexible circuit board 30 will ride on the hook 10, and the actuator 2 will therefore not be able to close. By this means, a poor insertion state of the flexible circuit board 30 can be detected.

Moreover, the metal actuator 2 is capable of being electrically connected to the flexible circuit board 30 by removing a portion of the insulation coating 7 over a predetermined region of the actuator 2. By electrically connecting a shield wire of the flexible circuit board 30 to the actuator 2, a shield circuit can be formed.

FIG. 5 shows a second embodiment of the present invention. In the second embodiment, the same reference symbols are appended to constitutions common to the first embodiment, and an explanation thereof is omitted.

In the second embodiment, more terminals 9 are provided than in the first embodiment. Moreover, an intermediate lock portion 20 is provided at the center portion of the main body 1, and an intermediate lock arm 23 is provided at a position of the actuator 2 corresponding to the intermediate lock portion 20.

At the position where the intermediate lock portion 20 of the main body 1 is mounted, a notch (not shown) which is similar to the notch 11 is provided. Furthermore, a notch 16 which is similar to that of the lock piece 14 is formed in the intermediate lock portion 20, and an opening (not shown) is formed along with the notch of the main body 1.

At a position of the base end portion of the actuator 2 corresponding to the intermediate lock portion 20, a pivot (not shown) is provided which is orthogonal to the longitudinal direction of the flexible circuit board and parallel to the surface thereof. The pivot is inserted into the opening whereby the actuator 2 is pivotably joined to the main body 1.

Moreover, at a position of the distal end portion of the actuator 2 corresponding to the intermediate lock portion 20, the intermediate lock arm 23, which is approximately U-shaped, is provided and extends in the thickness direction of the actuator 2.

When the actuator 2 is pivoted and closed, the distal end portion of the intermediate lock arm 23 is locked by the intermediate lock portion 20. Accompanying the increase in the number of terminals 9, the actuator 2 is pushed upward so as to bend by the reaction force of the terminals 9. However, due to the action of the intermediate lock, the connector of this embodiment is prevented from bending the actuator 2 even if the number of terminals is increased, and it is possible to guarantee the contact force between the conductor of the flexible circuit board and the electrode 8. In this embodiment, although the intermediate lock portion is only provided at one location in the center portion, it may be provided at several locations in accordance with need.

FIGS. 6A to 6C show a third embodiment of the present invention. In the third embodiment, the same reference symbols are appended to constitutions common to the first embodiment, and an explanation thereof is omitted.

Lock arms 4 are provided on both lateral sides of the actuator 2. Each lock arm 4 further extends in the thickness direction of the actuator 2, and the distal end portion thereof further extends toward the hinged side of the actuator 2 for forming a projection 5.

The lock piece 14 is mounted at both sides of the main body 1. The distal end of the projection 15 projects downward (vertical direction in FIGS. 7A and 7B) in the height direction of the main body 1. Furthermore, the notch 16 is formed in the lock piece 14, and the notch 16 and the notch 11, which is formed in the main body 1, together form the opening 13.

In the third embodiment, as shown in FIGS. 7a and 7b, the opening 13 into which the pivot 6 is inserted forms a roughly rectangular shape. For that reason, it is possible for the pivot 6 to slide within the opening 13 in the longitudinal direction of the flexible circuit board 30. Furthermore, a recess 26 is formed in a portion of the notch 16 of the lock piece 14. In other words, the width dimension (dimension in the vertical direction of FIG. 7) of the opening 13 is widened in the region where the recess 26 is formed. Accordingly, as shown in FIGS. 7a and 7b, the actuator 2 is pivotable by being in a lightly fitted state only when the pivot 6 is at the position where the recess 26 is formed. In contrast, when the pivot 6 is not at the position where the recess 26 is formed, the pivot 6 pivots about the notches 11 and 16.

As shown in FIG. 8, the slit 12a is formed parallel to the support surface 18 at both corner portions of the side walls 17 which surround the support surface 18 of the main body 1. At the side of the support surface 18 where the flexible circuit board 30 extends, a slit 12b is formed parallel to the support surface 18 so as to face the slit 12a. A pair of either only the slit 12a or 12b may be formed.

Next, the operation of attaching the flexible circuit board to the connector in the third embodiment will be explained. When the actuator 2 is made to slide toward the base end side of the flexible circuit board 30, the pivot 6 is made to match the position where the recess 26 is formed, and the pivot 6 becomes capable of pivoting. Since it is possible for the pivot 6 to pivot freely at this position, the actuator 2 can be opened by pivoting. While the actuator 2 is in the open state, the end portion of the flexible circuit board 30 is set in the connector from roughly perpendicularly above the connector. At this time, as shown in FIG. 8, the end portion of the side close to the distal end of the flexible circuit board 30 and to the distal end of the notch 32 is inserted into the slits 12a and 12b thereby making it possible to temporarily position the flexible circuit board 30.

Next, the actuator 2 is closed by pivoting about the pivot 6. At this time, the flexible circuit board 30 is held between the actuator 2 and the support surface 18, and placed in a temporarily stopped state. The actuator 2 is then made to slide toward the distal end side of the flexible circuit board 30. By this means, as shown in FIG. 7b, the projection 5 provided on the lock arm 4 is stopped by the projection 15 provided on the lock piece 14.

As described above, according to the present invention, it is possible to provide a connector which is flatter and has fewer parts than conventional connectors.

Furthermore, it is possible to provide a connector in which a flexible circuit board can be directly inserted roughly perpendicular to the connector without increasing the number of parts.

Furthermore, in the connector as described above, it is possible to raise the reliability of the contact with a conductor, thanks to the locking means 4, 14, 20, 23 which allow a sufficient latching strength between the parts.

1. A connector to be attached to an end portion of a planar flexible circuit board comprising: a main body having a support surface on which is placed a portion of said flexible circuit board of a predetermined length from a distal end thereof, the support surface provided with a terminal which contacts a conductor on one surface of said flexible circuit board; and an actuator which holds said flexible circuit board between said actuator and the support surface of the main body, wherein said actuator is pivotably joined to said main body at a base end portion of said actuator, and said actuator engages with said main body at a distal end portion of said actuator.

2. A connector according to claim 1, wherein said actuator forms a plate shape which overlaps with the portion of said flexible circuit board of a predetermined length, and said actuator is joined to said main body so as to be pivotable about a pivot which is orthogonal to the longitudinal direction of said flexible circuit board and parallel to the surface of said flexible circuit board.

3. A connector according to claim 1, wherein said actuator is provided with a protrusion which projects in the thickness direction of said actuator on the portion which overlaps with said flexible circuit board.

4. A connector according to claim 1, wherein said main body is provided with side walls which surround said support surface, the side walls forming a slit for insertion of the distal end of said flexible circuit board.

5. A connector according to claim 1, wherein said support surface is provided with a hook for positioning said flexible circuit board in the surface direction by engaging with a notch provided in said flexible circuit board.

6. A connector according to claim 2, wherein an opening for joining by said pivot of said actuator forms a roughly rectangular shape taking the longitudinal direction of said flexible circuit board as the length thereof, a recess is formed in the opening at the base end side of the flexible circuit board, and
said pivot is pivotable only when at a position where said recess is formed.

7. A connector according to claim 1, wherein a slit, into which an end portion at the side near the distal end of a notch provided in said flexible circuit board is inserted, is formed at the side of said main body where said flexible circuit board extends.

8. A connector according to claim 1, wherein said actuator is provided with an insulation coating on a surface that touches said flexible circuit board and/or at a surface on the rear side thereof.
